(19) United States
(12) Patent Application Publication
(10) Pub. No.: US 2025/0270762 A1
(43) Pub. Date: Aug. 28, 2025

(54) METHOD FOR PREPARING HYDROPHOBIC CELLULOSE USING PICKERING EMULSION AND HYDROPHOBIC CELLULOSE PREPARED USING THE SAME

(71) Applicant: KOREA RESEARCH INSTITUTE OF CHEMICAL TECHNOLOGY, Daejeon (KR)

(72) Inventors: Ji-Hoon SHIN, Daejeon (KR); Hyunho LEE, Daejeon (KR); Sae-Hume PARK, Daejeon (KR); Jeong-Suk YUK, Daejeon (KR)

(73) Assignee: KOREA RESEARCH INSTITUTE OF CHEMICAL TECHNOLOGY, Daejeon (KR)

(21) Appl. No.: 19/061,266

(22) Filed: Feb. 24, 2025

(30) Foreign Application Priority Data
Feb. 23, 2024 (KR) 10-2024-0026609

(51) Int. Cl. D21C 9/18; D21C 3/04

(52) U.S. Cl. CPC D21C 9/18; D21C 3/04

(57) ABSTRACT

Provided herein is a method for preparing hydrophobic cellulose using Pickering emulsion and hydrophobic cellulose prepared using the same. The hydrophobic cellulose prepared by the method has the effect of improved thermal stability and hydrophobicity.

### CROSS-REFERENCE TO RELATED APPLICATION

This application claims priority to Korean Patent Application No. 10-2024-0026609 filed on Feb. 23, 2024, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a method for preparing hydrophobic cellulose using Pickering emulsion and hydrophobic cellulose prepared using the same.

### 2. Description of the Related Art

Cellulose is hydrophilic and tends to strongly interact with water due to the presence of one primary hydroxyl group (C6) and two secondary hydroxyl groups (C2/C3) on each glucosyl unit. In addition, the hydrophobic planes derived from glucosyl units, which are rich in C—H groups along the axial direction, allow interactions with other hydrophobic compounds in water.

Research on the surface chemistry of cellulose-based materials has garnered widespread attention. Chemical control of the cellulose surface can significantly affect the dispersion behavior of cellulose in polar or non-polar, hydrophilic or hydrophobic materials.

In particular, the abundant hydroxyl groups on the cellulose surface impart hydrophilic and polar characteristics, enabling the potential for physical and chemical interactions. Therefore, surface modifications have been performed to introduce negative charges and reactive chemicals using synthetic strategies during or after cellulose production.

In particular, functionalized cellulose, obtained by converting hydroxyl groups (C6-OH) into sulfate ester or carboxylate groups using industrial methods such as sulfuric acid hydrolysis and TEMPO oxidation, can form permanently stable CNC dispersions in aqueous phases.

However, despite these various approaches, it remains an unresolved challenge to achieve uniform and stable dispersion of cellulose in hydrophobic media of common organic solvents and non-polar polymer matrices, due to the formation of hydrophilic aggregates of cellulose.

Surface functionalization of cellulose can be largely classified into two categories.

The first involves physical bonding or non-covalent interactions, including electrostatic interactions, hydrophilic affinity, hydrogen bonding, and van der Waals forces, in respect to amphiphilic block copolymers fixed on polysaccharide-derived oligomer surfaces as well as anionic, cationic, and non-ionic surfactants.

This method has been applied to nanocomposites based on poly(propylene), poly(lactide), ethylene/a-olefin copolymer elastomers, and poly(styrene). Although this approach can be easily carried out, it often requires a large amount of surfactant to completely cover the cellulose surface.

Furthermore, desorption of the surfactant can occur due to the weak non-covalent interactions of the monodentate type, which may weaken the mechanical properties of the resulting composite.

The second approach involves covalently bonding organic functional moieties to the cellulose surface through various methods. These include partial silylation, acetylation, coupling reactions with isocyanate groups, and esterification with succinic anhydride derivatives, such as acyl chlorides and alkenyl succinic anhydrides.

However, these methods require polar aprotic solvent systems such as N-methyl-2-pyrrolidone (NMP), N,N-dimethylformamide (DMF), and 1,4-dioxane due to the hydrophobic nature of the chemicals used. These systems necessitate complex procedures, such as solvent exchange, resulting in relatively low yields.

### SUMMARY OF THE DISCLOSURE

The purposed of the present disclosure is to provide a method for preparing hydrophobic cellulose using Pickering emulsion and hydrophobic cellulose prepared using such method.

The problems to be solved by the present disclosure are not limited to those mentioned above, and other issues not explicitly stated will be clearly understood by those skilled in the art from the following description.

In order to achieve the purpose, an aspect of the present disclosure provides a method for preparing hydrophobic cellulose, the method comprising: preparing an oil-in-water Pickering emulsion of a suspension of cellulose (aqueous solution) and a solution in which an acid anhydride is mixed with an organic solvent (oleaginous solution); and freeze-drying and then heat treatment of the freeze-dried emulsion.

In some exemplary embodiments, the acid anhydride may be represented by Chemical Formula 1.

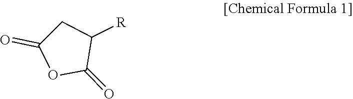

In Chemical Formula 1, R is a C₅₋₂₀ alkyl or alkylene group.

In some exemplary embodiments, a weight ratio of the aqueous solution to the oleaginous solution may range from 80:20 to 99:1.

In some exemplary embodiments, a content of the cellulose in the aqueous solution may range from 0.01 to 2 wt %.

In some exemplary embodiments, a content of the acid anhydride in the oleaginous solution may range from 1 to 20 wt %.

In some exemplary embodiments, a weight ratio of the cellulose to the acid anhydride in the emulsion may range from 1:1 to 1:10.

In some exemplary embodiments, the emulsion may be stabilized by the cellulose at an interface between an aqueous phase and an oleaginous phase.

In some exemplary embodiments, an average diameter of droplets of the emulsion may range from 2 to 6 μm.

In some exemplary embodiments, the freeze-drying of the emulsion may form a cellulose capsule internally coated with a hydrophobic chain derived from the acid anhydride.

In some exemplary embodiments, the heat treatment may cause the acid anhydride to form a covalent bond with a hydroxyl group of the cellulose, resulting in grafting.

In some exemplary embodiments, the heat treatment may be performed at a temperature ranging from 100 to 170° C.

In addition, another aspect of the present disclosure provides a method for preparing hydrophobic cellulose, the method comprising steps of:
(a) preparing a first solution by dispersing cellulose with aqueous solvent;
(b) preparing a second solution by dissolving acid anhydride with organic solvent;
(c) preparing an oil-in-water Pickering emulsion by mixing the first solution with the second solution; and
(d) freeze-drying and then heat treatment of the emulsion prepared in the step (c).

In addition, still another aspect of the present disclosure provides a hydrophobic cellulose capsule internally coated with hydrophobic chains derived from acid anhydrides.

In addition, still another aspect of the present disclosure provides hydrophobic cellulose grafted with hydrophobic chains derived from acid anhydrides.

In some exemplary embodiments, in the hydrophobic cellulose, cellobiose grafted with the acid anhydride accounts for 20 to 60 mol % of the hydrophobic cellulose.

In some exemplary embodiments, the degree of substitution (DS) of hydroxyl groups (—OH) in the hydrophobic cellulose may range from 0.05 to 1.

In some exemplary embodiments, in the hydrophobic cellulose, a weight ratio of the acid anhydride to the cellulose ranges from 20:80 to 40:60.

The method for preparing hydrophobic cellulose according to an exemplary embodiment of the present disclosure has the effect of enabling the easy production of hydrophobic cellulose.

The hydrophobic cellulose prepared according to an exemplary embodiment of the present disclosure has the effect of improved thermal stability and hydrophobicity.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a process flowchart of the method for preparing hydrophobic cellulose according to an exemplary embodiment of the present disclosure.

FIG. 2 schematically illustrates the method for preparing hydrophobic cellulose using Pickering emulsion according to an exemplary embodiment of the present disclosure.

FIG. 3 shows fluorescence microscopy images of Pickering emulsions CNC95-CHX05 [prepared using an organic solvent without TDSA and an aqueous cellulose suspension] and CNC95-CHX05 (TDSA10) [prepared using an organic solvent containing TDSA (10 wt % in CHX) and an aqueous cellulose suspension] that are prepared according to an exemplary embodiment of the present disclosure, where the areas marked with circles (O) represent the oleaginous phase and the parts in gray background represent the aqueous phase; and graphs depicting the droplet diameter distribution of CNC95-CHX05 (dashed line on the left) and CNC95-CHX05 (TDSA10) (solid line on the right).

FIG. 4 is a graph showing the viscosity (fluidity of the oil phase) according to the content of acid anhydride (TDSA) in the organic solvent (CHX) of the Pickering emulsion prepared according to an exemplary embodiment of the present disclosure.

FIG. 5 schematically illustrates, at the top, a method for observing Pickering emulsions using Cryo-SEM [CNC concentration in the aqueous phase (W): 0.2 wt %; O/W ratio 5/95 (w/w)] according to an exemplary embodiment of the present disclosure, and at the bottom left, Cryo-SEM images of Pickering emulsions prepared without adding acid anhydride (TDSA), and at the bottom right, Cryo-SEM images of Pickering emulsions prepared with the addition of acid anhydride (TDSA, 10 wt % in CHX). The insets schematically depict the droplets.

FIG. 6 illustrates, on the left side, Fourier transform infrared (FT-IR) spectra of TDSA, CNC, unmodified CNC, and TDSA-grafted CNC, and on the right side, SEM images of the TDSA-grafted CNC and unmodified CNC, according to an exemplary embodiment of the present disclosure.

FIG. 7 shows XPS high-resolution C 1s spectra of CNC and CNC-graft-TDSA (obtained after esterification and washing), according to an exemplary embodiment of the present disclosure.

FIG. 8 illustrates, at the top, TGA thermal analysis results, and at the bottom, DTG curves showing the onset and maximum thermal decomposition temperature (T_{d onset} and T_{d max}) of TDSA, CNC, and CNC-graft-TDSA, according to an exemplary embodiment of the present disclosure.

FIG. 9 shows the X-ray diffraction (XRD) analysis results of CNC and CGT (CNC-graft-TDSA), according to an exemplary embodiment of the present disclosure.

FIG. 10 illustrates, on the left side, hydrophobicity test results based on wettability using water, chloroform (CHCl₃) and toluene [solvent density: CHCl₃>water>toluene; cellulose density: 1.5 g cm⁻¹], and on the right side, dispersion stability test results over time for CNC and CNC-graft-TDSA (CGT) [solvent polarity index: water (10.2)>CHCl₃ (4.1)>toluene (2.4); dispersed at 0.1 wt %, vortexed for 1 min, and sonicated for 3 min], according to an exemplary embodiment of the present disclosure.

FIG. 11 illustrates, on the left side, representative TEM images (inset: transparency behavior of suspensions at 0.1 wt %), and on the right side, length (left) and width (right) distribution histograms with mean values±standard deviation of CNC dispersed in water and CNC-graft-TDSA dispersed in chloroform, according to an exemplary embodiment of the present disclosure.

FIG. 12 shows the water droplet contact angle of films based on CNC and CNC-graft-TDSA obtained at 8 seconds and 30 seconds, respectively, through Pickering emulsions, according to an exemplary embodiment of the present disclosure.

### DETAILED DESCRIPTION OF THE DISCLOSURE

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail.

### Method for Preparing Hydrophobic Cellulose

According to an exemplary embodiment of the present disclosure, a method for preparing hydrophobic cellulose is provided. The method comprises: preparing an oil-in-water Pickering emulsion of a suspension of cellulose (aqueous solution) and a solution in which an acid anhydride is mixed with an organic solvent (oleaginous solution); and freeze-drying and then heat treatment of the freeze-dried emulsion.

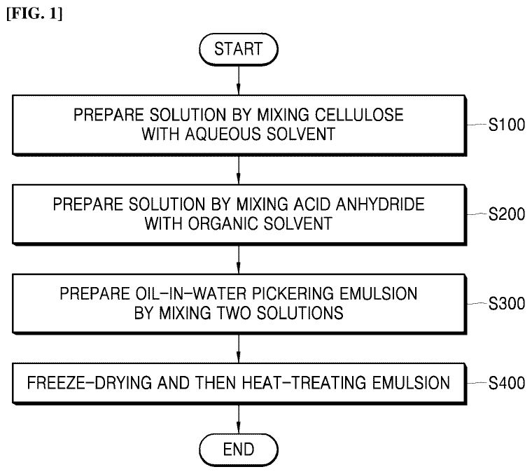

FIG. 1 is a process flowchart of the method for preparing hydrophobic cellulose according to an exemplary embodiment of the present disclosure.

Hereinafter, a detailed description will be provided with reference to FIG. 1.

First, a solution (aqueous solution) may be prepared by mixing cellulose with an aqueous solvent (S100).

In this step, an aqueous cellulose suspension can be prepared by mixing cellulose with the aqueous solvent.

The aqueous solvent may include water, distilled water, injectable distilled water, physiological saline, or a buffer solution.

The cellulose contains cellobiose, the basic unit of cellulose (in which two β-glucose molecules are linked by a β-1,4 bond). In addition, the cellulose may be nanocellulose. For example, the cellulose may be cellulose nanocrystals (CNC) or cellulose nanofibers (CNF), but is not limited thereto.

After mixing cellulose with the aqueous solvent, a salt such as NaCl may be additionally added.

Next, a solution (oleaginous solution) may be prepared by mixing an acid anhydride with an organic solvent (S200).

In this step, an oleaginous solution can be prepared by mixing an acid anhydride with an organic solvent.

The organic solvent is not particularly limited as long as it can dissolve the acid anhydride, and a solvent commonly used in the relevant technical field for dissolving acid anhydrides may be used.

The acid anhydride may be represented by Chemical Formula 1.

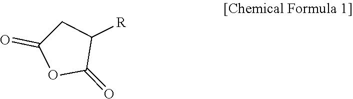

In Chemical Formula 1, R is a C₅₋₂₀ alkyl or alkylene group.

Examples of the acid anhydride include tetradecenyl succinic anhydride, octenyl succinic anhydride, and tetradecyl succinic anhydride.

Next, the solution of the step S100 and the solution of the step S200 may be mixed to prepare an oil-in-water Pickering emulsion (S300).

This step involves mixing and dispersing the aqueous solution of the step S100 and the oleaginous solution of the step S200 to prepare an oil-in-water (O/W) Pickering emulsion.

The emulsion may be an oil-in-water emulsion in which the aqueous solution of the step S100 serves as the continuous phase and the oleaginous solution of the step S200 serves as the dispersed phase. This emulsion can be stabilized by cellulose at the interface between the aqueous phase (continuous phase) and the oleaginous phase (dispersed phase).

A weight ratio of the aqueous solution to the oleaginous solution may range from 80:20 to 99:1.

The weight ratio is set to produce a stabilized Pickering emulsion with uniformly sized droplets. When the weight ratio falls outside the specified range, issues may arise regarding the stability of the emulsion and the average droplet size.

A content of the cellulose in the aqueous solution may range from 0.01 to 2 wt %.

When the cellulose content in the aqueous solution falls outside the specified range, the stability of the Pickering emulsion and the average droplet size may be affected.

A content of the acid anhydride in the oleaginous solution may range from 1 to 20 wt %.

When the acid anhydride content in the oleaginous solution falls outside the specified range, the stability of the Pickering emulsion and the average droplet size may be affected.

The weight ratio of cellulose to acid anhydride added during emulsion preparation, as described above, may range from 1:1 to 1:10, preferably from 1:1 to 1:5, and more preferably from 1:2 to 1:3.

When the weight ratio falls outside the specified range, the stability of the Pickering emulsion and the average droplet size may be affected.

The average diameter of the emulsion droplets prepared by the above method may range from 2 to 6 μm, preferably from 3 to 5 μm, and more preferably from 3.5 to 4.5 μm.”

In the exemplary embodiment of the present disclosure, it was confirmed that the average droplet diameter (D[4.3]=3.9 μm) of the Pickering emulsion prepared by adding an acid anhydride to the oleaginous phase significantly decreased compared to the average droplet diameter (D[4.3]=7.4 μm) of the Pickering emulsion prepared without adding an acid anhydride to the oleaginous phase.

Next, the emulsion prepared in the step S300 may be freeze-dried and then heat-treated (S400).

Through the freeze-drying of the emulsion, cellulose capsules whose interior is coated with a hydrophobic chain derived from acid anhydride may be formed, and preferably, cellulose microcapsules may be formed.

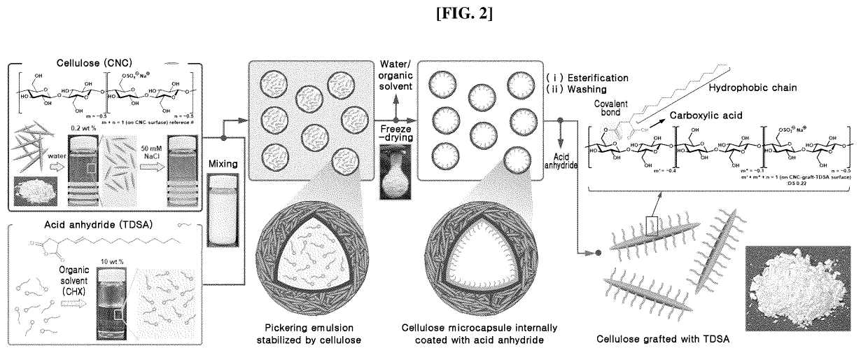

Referring to FIG. 2, during the preparation of the oil-in-water Pickering emulsion, droplets of the oleaginous solution (oleaginous phase, dispersed phase), in which the acid anhydride is dissolved, are formed within the cellulose suspension (aqueous phase, continuous phase). Cellulose adsorbs at the interface between the aqueous phase and the oleaginous phase, stabilizing the emulsion. By freeze-drying the emulsion, the organic solvent within the droplets is removed, resulting in the formation of cellulose capsules internally coated with the acid anhydride.

Through the heat treatment process, the acid anhydride may form covalent bonds with the hydroxyl groups of cellulose, resulting in grafting. The covalent bond may be formed through an esterification reaction between the hydroxyl groups of cellulose and the acid anhydride.

The heat treatment may be conducted at a temperature ranging from 100 to 170° C.

When the temperature falls outside this range, the esterification reaction may not proceed efficiently.

Through the freeze-drying and heat treatment, the hydrophobic cellulose grafted with the acid anhydride may be obtained.

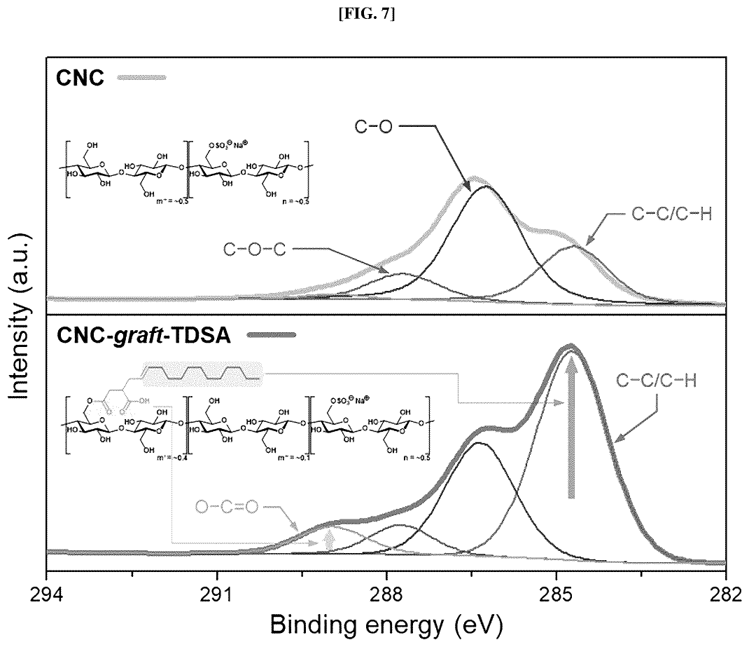

Among the hydrophobic cellulose, the cellobiose grafted with the acid anhydride may account for 20 to 60 mol % of the hydrophobic cellulose, preferably 30 to 50 mol %, and more preferably 35 to 45 mol % (Tables 2 and 3, FIG. 7).

After the freeze-drying and heat treatment, an additional process may be performed to remove residual salts from the aqueous solution and excess unreacted acid anhydride from the oleaginous solution. For example, this process may be carried out using a cosolvent, followed by washing and filtration.

### Hydrophobic Cellulose Capsule

The present disclosure provides hydrophobic cellulose capsules internally coated with a hydrophobic chain derived from an acid anhydride.

The hydrophobic cellulose capsules may be prepared by the aforementioned method, wherein an interior of the hydrophobic cellulose capsule may be coated with hydrophobic chains derived from an acid anhydride.

The cellulose capsules may preferably be cellulose microcapsules. The average diameter of the cellulose (micro) capsules may range from 2 to 6 μm, preferably from 3 to 5 μm, and more preferably from 3.5 to 4.5 μm.

The hydrophobic chain derived from the acid anhydride may be represented by Chemical Formula 2 below.

In Chemical Formula 2, * indicates the site where the structure is linked to the hydroxyl group (—OH) of cellulose.

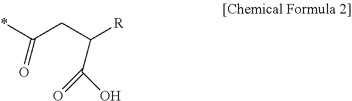

In Chemical Formula 2, R is a C₅₋₂₀ alkyl or alkylene group.

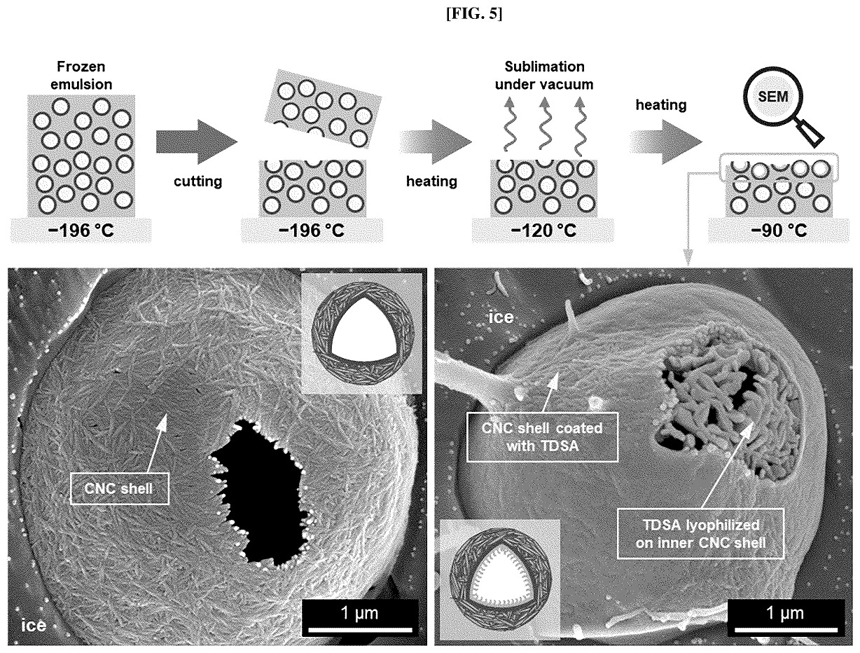

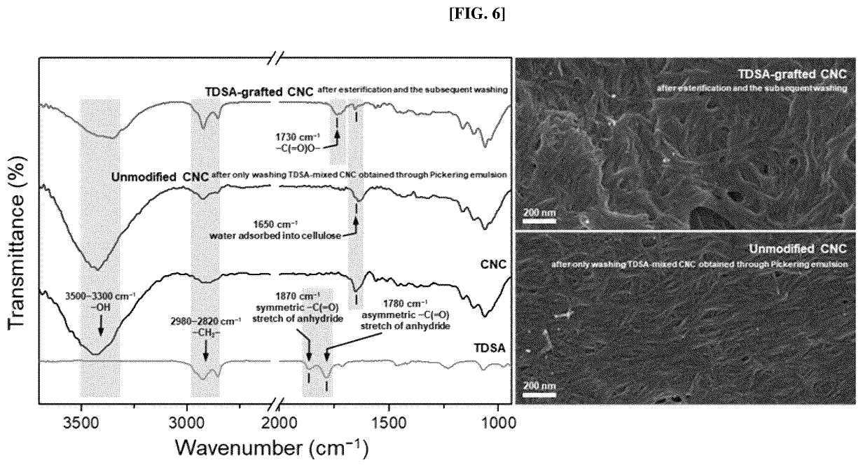

The cellulose capsules may have acid anhydride uniformly bonded within the cellulose shell [FIG. 5(c)]. Additionally, in the cellulose capsules, the acid anhydride may be grafted onto the cellulose surface through covalent bonding, and the cellulose surface may become smoother and thicker as a result of the grafting of the acid anhydride [FIG. 6(a), (b)].

### Hydrophobic Cellulose

The present disclosure provides hydrophobic cellulose grafted with a hydrophobic chain derived from an acid anhydride.

The hydrophobic cellulose may be prepared from the aforementioned cellulose capsules.

The hydrophobic cellulose may be prepared by pulverizing the cellulose capsule described above. In particular, the hydrophobic cellulose may be prepared by washing and pulverizing the cellulose capsules.

Among the hydrophobic cellulose, the cellobiose grafted with the acid anhydride may account for 20 to 60 mol % of the hydrophobic cellulose, preferably 30 to 50 mol %, and more preferably 35 to 45 mol % (Tables 2 and 3, FIG. 7).

In the hydrophobic cellulose, the degree of substitution (DS) of hydroxyl groups (—OH) may range from 0.05 to 1, preferably 0.1 to 0.5. The hydroxyl group substitution degree (DS=0.22) of the hydrophobic cellulose prepared according to an exemplary embodiment of the present disclosure is significantly higher than that of hydrophobic cellulose (DS=0.0165) prepared by simple stirring without Pickering emulsion formation, as reported in Kuga et al., Biomacromolecules 2006, 7, 696-700, “Surface acylation of cellulose whiskers by drying aqueous emulsion” (Tables 2 and 3).

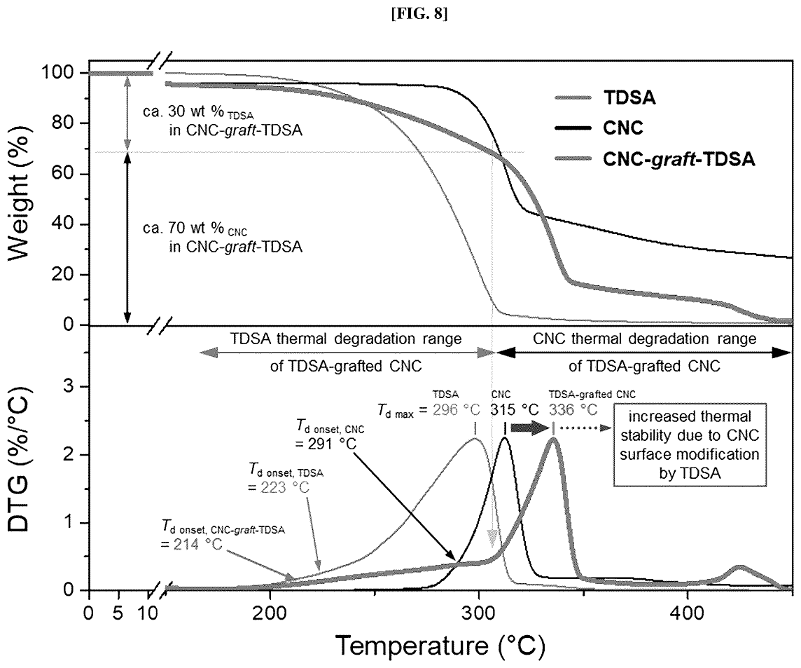

The hydrophobic cellulose may exhibit improved thermal stability due to the grafting of long alkenyl/alkyl chains of the acid anhydride [FIG. 8(b), T_{dmax}: 315° C.→336° C.

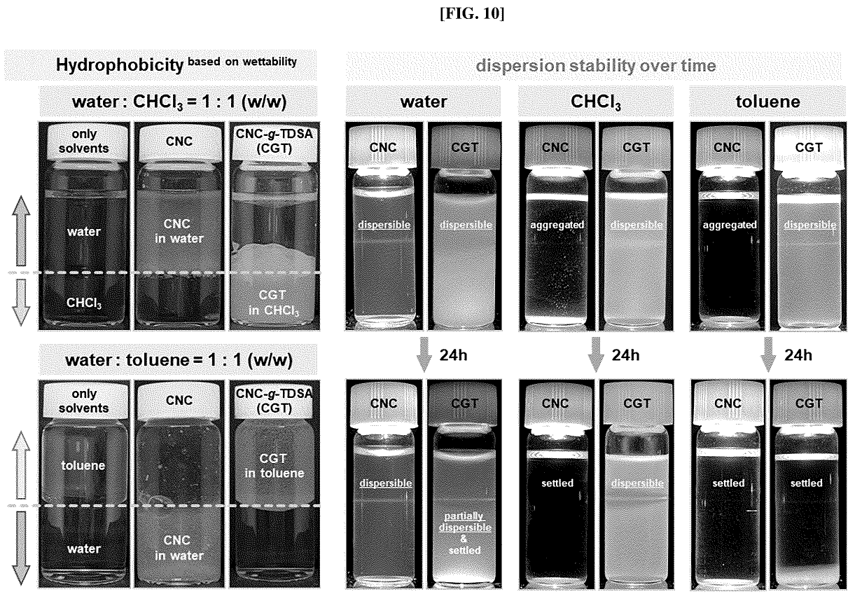

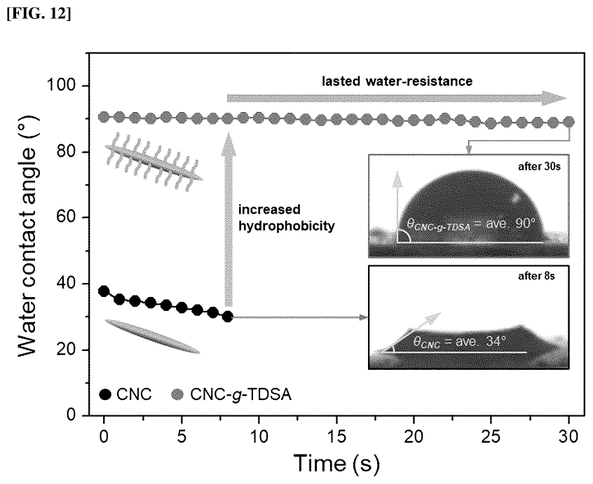

The hydrophobic cellulose may exhibit enhanced hydrophobicity, including improved wettability and dispersibility in organic solvents, compared to pure cellulose [FIG. 10(a), (b)], and its surface hydrophobicity (WCA) may also be increased [FIG. 12: 34°→90°].

In the hydrophobic cellulose, the weight ratio of acid anhydride to cellulose may range from 20:80 to 40:60, preferably 30:70 [FIG. 8(b), TDSA region: 100-310° C./CNC^{backbone} region: 311-400° C.].

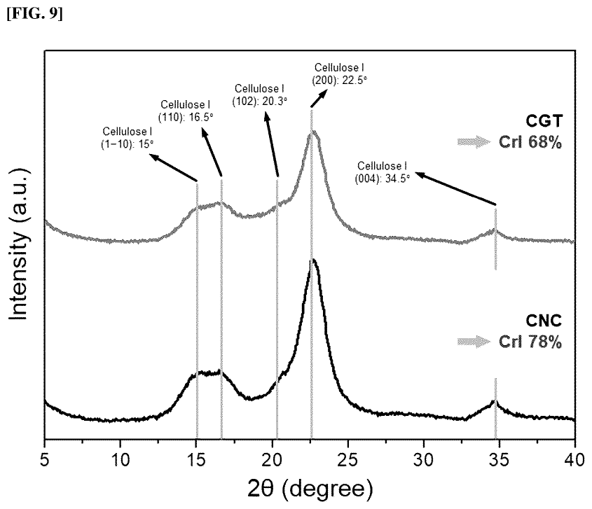

The hydrophobic cellulose may retain the crystalline structure of cellulose I even after surface modification through covalent bonding with the acid anhydride (FIG. 9).

The average length of the hydrophobic cellulose may range from 150 to 400 nm, preferably 180 to 370 nm. The average width of the hydrophobic cellulose may range from 5 to 40 nm, preferably 10 to 35 nm.

Hereinafter, exemplary embodiments will be described in detail to provide a more specific explanation of the present disclosure. However, the exemplary embodiments of the present disclosure may be modified in various ways, and the scope of the present disclosure should not be construed as being limited to the exemplary embodiments described below. The exemplary embodiments of the present disclosure are provided to more fully explain the present disclosure to those of ordinary skill in the art.

In the description of the present disclosure and the following exemplary embodiments, CNC-graft-TDSA, CNC-g-TDSA, and CNC grafted with TDSA are used interchangeably with the same meaning.

### Material

A commercial-grade cellulose nanocrystal (CNC) powder, CelluForce NCC®, produced by 64 wt % sulfuric acid hydrolysis of bleached kraft pulp, was purchased from CelluForce Inc. (Canada).

n-Tetradecenyl succinic anhydride (TDSA, >85.0%, GC) was purchased from Tokyo Chemical Industry Co., LTD, and due to its moisture sensitivity, it was stored in a nitrogen-filled glove box.

Nile red (>98.0%) and Calcofluor White for microscopy, osmium tetroxide (OsO₄, 4 wt % in H₂O) for electron microscopy, potassium bromide (99.0%) for FT-IR, and poly(styrene)-block-poly(isoprene)-block-poly(styrene) (SIS) (Mn, _{by SEC}=180 kg mol⁻¹ (Ð=1.3), containing 26 wt % diblock determined by SEC), a thermoplastic elastomer (TPE) composed of poly (styrene) (PS, 14 wt %) hard domains and poly (isoprene) (PI) soft segments (which are microphase-separated), were purchased from Sigma-Aldrich.

In order to remove impurities and antioxidants, SIS was used after purification as follows: SIS pellets were dissolved in chloroform (5% w/v solution) and purified by filtration through silica (0.040-0.063 mm). The resulting filtrate was precipitated in methanol. The precipitated SIS was dried under vacuum at 60° C. for 3 days.

All solvents, including sodium chloride (99.0%), acetone (99.5%), chloroform (99.5%), cyclohexane (CHX, 99.0%), and toluene (99.5%), were supplied by Samchun Chemicals Co., Ltd., and were used as received without further purification.

### Method

### (1) Confocal Laser Scanning Microscopy (CLSM)

To investigate the microstructure of CNC-stabilized Pickering emulsions [CNC95-CHX05 and CNC95-CHX05 (TDSA10)], with or without the addition of TDSA, a confocal laser scanning microscope (CLSM, LSM 880 with Airyscan, Carl Zeiss, Germany) was used.

The emulsions were prepared by Ultra-Turrax processing of a mixture containing a CNC suspension (0.2 wt %) with 50 mM NaCl and either CHX containing TDSA (10 wt %) or CHX alone at a weight ratio of 95:5. The CLSM observations were performed using a 40× or 63× oil immersion objective lens (Zeiss, Germany).

To provide more detailed visualization in the experiment, before observation, 1 mL of Calcofluor White solution (1 mg 1 mL⁻¹ ethanol) and Nile Red solution (1 mg 1 mL⁻¹ ethanol) were each added to the emulsion (10 mL), allowing the CNC particles in the aqueous phase and the oil droplets to be stained.

### (2) Particle Size Analysis

The size of oil droplets, depending on the weight ratio of the CNC suspension to oil and the presence or absence of TDSA, was measured using a particle analyzer (Mastersizer 3000-Maz6140, Malvern Instruments Ltd., UK).

### (3) Viscosity Measurement

The relative viscosity of the oleaginous phase containing TDSA was evaluated using a Brookfield viscometer (Brookfield DV-II, USA) with spindle SC4-21 at a temperature of 23±1° C. and a rotational speed of 173-200 rpm.

### (4) Cryogenic Scanning Electron Microscopy (Cryo-SEM)

Cryo-SEM analysis was performed to observe the presence of CNC particles and TDSA molecules within the droplets during the freeze-drying process of the Pickering emulsion, as water and CHX were removed.

A droplet of the emulsion was placed on a sample holder and cryo-fixed at −196° C. using liquid nitrogen. The mid-section of the droplet was cut using a cryostat (Quorum PP3010T, Quorum Technologies Ltd., United Kingdom) to examine the internal structure of the droplet. The sample holder was then transferred to a cryo-SEM system (Crossbeam 550, Carl ZEISS, Germany).

In order to enhance contrast in the Cryo-SEM images, freeze-etching was performed, followed by acquiring secondary electron images at an accelerating voltage of 2 kV in the Cryo-SEM system, with subsequent light gold coating.

### (5) Fourier Transform Infrared Spectroscopy (FT-IR)

The chemical structure of CNC after surface modification was analyzed using FT-IR (Cary 630 FT-IR, Agilent Technologies, USA) in the range of 4000˜400 cm⁻¹.

For FT-IR analysis, hydrated samples (TDSA, CNC, unmodified CNC, and CNC grafted with TDSA, each 4 mg) were mixed with 150 mg of KBr powder and compressed into pellets using a mold.

### (6) Field Emission Scanning Electron Microscopy (FE-SEM)

CNC grafted with TDSA was prepared through a thermal esterification reaction, followed by washing. Unmodified CNC was obtained by washing TDSA-mixed CNC obtained via the Pickering emulsion method without further modification.

Their surface morphology was examined using FE-SEM (MIRA 3, Tescan, Czech Republic) at an accelerating voltage of 20 kV.

The fracture surfaces of tensile bars from the SIS, SIS/CNC series, and SIS/CNC-g-TDSA series were observed via FE-SEM analysis after tensile testing.

### (7) X-Ray Photoelectron Spectroscopy (XPS)

XPS analysis was performed to examine the chemical bonding on the sample surface using a K-alpha instrument (Thermo VG Scientific Equipment, USA) equipped with a monochromatic Al Kα (1486.7 eV) X-ray source under ultrahigh vacuum conditions (10⁻⁹ Torr).

For accurate analysis, the binding energies of all spectra were calibrated using the C—C/C—H component (284.8 eV) of the C1s peak.

### (8) Elemental Analysis (EA)

Elemental analysis (EA) was performed using an elemental analyzer (Thermo Scientific Flash 2000 CHNS/O analyzer) to determine the C, H, and O weight percentages of CNC (CelluForce NCC®) and CNC-g-TDSA.

The collected data was used to calculate the degree of substitution (DS), which represents the number of modified hydroxyl groups per three hydroxyl groups in an anhydroglucose unit (AGU).

The analysis was conducted three times, and the average value was used.

### (9) Thermogravimetric Analysis (TGA)

In order to study the thermal decomposition behavior of the samples, TGA and DTG (derivative thermogravimetric analysis) curves were obtained using a TA Q500 thermogravimetric analyzer under N₂ gas flow at a heating rate of 10° C. min⁻¹ in the temperature range of 25˜600° C.

### (10) X-Ray Diffraction (XRD)

XRD measurements were performed using an Ultima IV X-ray diffractometer (Rigaku, Japan) with Cu radiation (λ=0.154 nm), operating at 40 kV and 40 mA. This analysis aimed to investigate the crystalline structure of CNC after surface modification.

X-ray diffraction patterns were recorded within a 2θ range of 5˜40° at a scanning speed of 0.03° sec⁻¹.

The crystallinity index (CrI) of the samples was determined using the Segal equation as follows:

$$CrI ( \% ) = [ ( {I}_{{200 )}^{-}} {I}_{a m} ) / {I}_{200} ] \times 100$$

Here, I₂₀₀ is the maximum intensity observed at a 2θ angle between 22° and 23° corresponding to the lattice diffraction of the crystalline plane (200) of the sample, and Iₐₘ is the intensity of the amorphous reflection observed at a 2θ angle between 18° and 19°.

### (11) Hydrophobicity and Dispersion Stability Test

In order to investigate the surface properties of CNC and CNC-g-TDSA, a hydrophobicity test was conducted based on wettability and dispersion stability over time.

A solvent system containing either water and chloroform or water and toluene was prepared at the same weight ratio. Phase separation was observed due to the density differences between the solvents (water=1 g cm⁻¹, chloroform=1.49 g cm⁻¹, toluene=0.87 g cm⁻¹).

Subsequently, CNC or CNC-g-TDSA samples were added to the solvent mixtures and gently shaken, after which the phase behavior was carefully observed. The nanoparticles were dispersed in the solvents at a concentration of 0.1 wt % by subjecting them to vortex mixing for 1 min, followed by ultrasonication at 30% amplitude for 3 min.

The dispersion stability of the samples was measured in water, chloroform, and toluene over time. Their presence was determined using the Tyndall effect by employing a He—Ne laser (632.8 nm).

### (12) Transmission Electron Microscopy (TEM)

In order to measure the dimensions of CNC and CNC-g-TDSA particles that were respectively redispersed in water or chloroform, TEM analysis was performed using a JEM-2100F (JEOL Ltd., Japan) at an accelerating voltage of 200 kV.

The suspensions were diluted to 0.01 wt % using the respective solvents, and a droplet of each suspension was placed on a thin carbon-coated 200-mesh copper grid (CF200-Cu, Electron Microscopy Sciences, USA) without staining. TEM images were captured in bright-field mode using diffraction contrast, without prior contrast enhancement.

From the TEM images obtained using Gatan Digital Micrograph software (Gatan, Inc., USA), at least 100 particles were measured to construct the size distribution of particle length and width.

The macroscopic morphology of SIS was also observed using TEM analysis. Ultrathin sections were prepared at −120° C., below the glass transition temperature of PI (T_{g}=ca. −56° C.), using an ultramicrotome (Leica Ultracut UC7, Leica Microsystems, Austria) equipped with a Leica EM FC7 cryo-chamber a diamond knife, installed in the Korea Basic Science Institute (KBSI).

The ultrathin film sections (70-100 nm width) were stained for 1 hour in vapor from an osmium tetroxide (OsO₄) aqueous solution (4 wt % in H₂O) to enhance contrast.

### (13) Contact Angle Measurement

Water contact angle (WCA) analysis was performed using a drop shape analyzer (DSA 100, KRUSS, Germany) on the surface of films prepared by compressing the samples in air at room temperature.

A 2 μL droplet of deionized water was deposited onto the film surface using a Hamilton syringe at 23° C. The image of the deposited droplet was captured at 1-second intervals for 30 seconds, and the contact angle was calculated using DSA1 software (KRUSS, Germany).

### (14) Size Exclusion Chromatography (SEC)

SEC analysis was performed using an Agilent 1260 Infinity LC system (Agilent Technologies, Santa Clara, USA) equipped with a refractive index detector to determine the diblock content of SIS, as well as its number-average molecular weight (Mn) and weight-average molecular weight (Mw).

SIS pellets were diluted in tetrahydrofuran (THF, stabilized for HPLC≥99.5%, J.T.Baker) as the mobile phase (5 mg mL⁻¹). The solution was passed through three consecutive Styragel columns (HT4, HT3, and HT2, 7.5×300 mm each) at 40° C., maintaining a constant flow rate (1 mL min⁻¹).

Molecular weight values were determined by applying a calibration curve based on seven polystyrene standards (Shodex, Showa Denko, Tokyo, Japan).

### (15) Dynamic Mechanical Analysis (DMA)

DMA was performed using an MCR 302e rheometer (Anton Paar, Australia) equipped with a CTD 450 chamber.

The prepared specimens were subjected to a torsion test at a frequency of 1 Hz and a torsional strain of 0.01-0.1%.

The temperature was increased from −70° C. to 125° C. at a heating rate of 5° C. min⁻¹ under an N₂ atmosphere.

### (16) Tensile Test

Stress-strain (S-S) curves were obtained by performing tensile tests on both pure SIS and SIS composite films reinforced with CNC and CNC-g-TDSA.

The tests were conducted using a universal testing machine (Instron 5567, Instron Corporation, USA) at 23° C. and 40% humidity.

Dog-bone-shaped film specimens were tested according to ASTM D1708 using a 1 kN load cell, and they were stretched at a constant speed of 100 mm min⁻¹ until failure.

### Exemplary Embodiment 1 [CNC95-CHX05(TDSA10)]

As illustrated in FIG. 2, a CNC suspension (0.2 wt %) was prepared by mixing pure CNC (CelluForce NCC®) into an aqueous solution containing 50 mM NaCl.

Separately, a solution in which TDSA (tetradecenylsuccinic anhydride) is dissolved at 10 wt % in cyclohexane (CHX) was prepared.

These two solutions were then homogenized at a weight ratio of CNC suspension (CNC 0.2 wt %) to CHX solution (TDSA 10 wt %) of 95:5 using an Ultra-Turrax homogenizer (10,000 rpm) to prepare an oil-in-water Pickering emulsion.

The prepared Pickering emulsion was freeze-dried, resulting in the formation of CNC microcapsules internally coated with TDSA. Subsequently, a heat treatment at 130° C. was performed to facilitate esterification between the hydroxyl groups of CNC and the anhydride groups of TDSA.

A cosolvent system of acetone/water (70/30 weight ratio) was applied to remove residual NaCl from the aqueous CNC suspension and excess unreacted TDSA.

### Comparative Example 1 [CNC95-CHX05]

The same procedure as in Exemplary embodiment 1 was conducted, except that TDSA was not added to the cyclohexane (CHX) solution.

### Experimental Example

### (1) Average Droplet Diameter of Pickering Emulsions depending on Acid Anhydride Addition

The microstructure and average droplet diameter (D) of the prepared two emulsions of CNC95-CHX05 and CNC95-CHX05 (TDSA10) were determined using confocal laser scanning microscopy (CLSM) and particle size analysis.

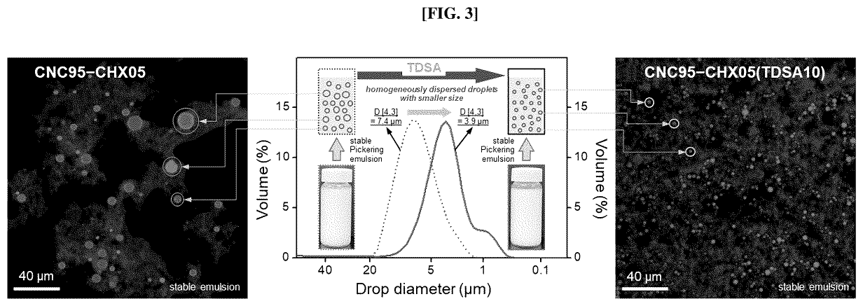

Referring to FIG. 3, both CNC95-CHX05 and CNC95-CHX05(TDSA10) emulsions exhibited a milky-white appearance (middle inset of FIG. 3).

The merged confocal images of CNC95-CHX05 show that all oleaginous-phase droplets (stained red with Nile Red) have average droplet sizes of 7.4 μm, and were well dispersed in the aqueous phase having CNC clusters (stained blue with Calcofluor White) located at the oleaginous-aqueous interface.

The oleaginous-phase droplets (red) of CNC95-CHX05(TDSA10) were uniformly distributed and uniformly surrounded by CNC clusters (blue). This indicates that a CNC network was evenly formed around the oleaginous-aqueous interface of the droplets, regardless of the presence of TDSA.

However, the average droplet size of the emulsion [CNC95-CHX05(TDSA10)], in which the CHX phase containing TDSA composed of hydrophilic succinic anhydride and hydrophobic C14 alkyl and alkenyl chains was homogenized in the aqueous CNC suspension, significantly decreased to 3.9 μm, in comparison to 7.4 μm for CNC95-CHX05 (middle of FIG. 3; Table 1).

This is because the surface tension of the dispersed phase can be reduced by TDSA, which exhibits amphiphilic characteristics.

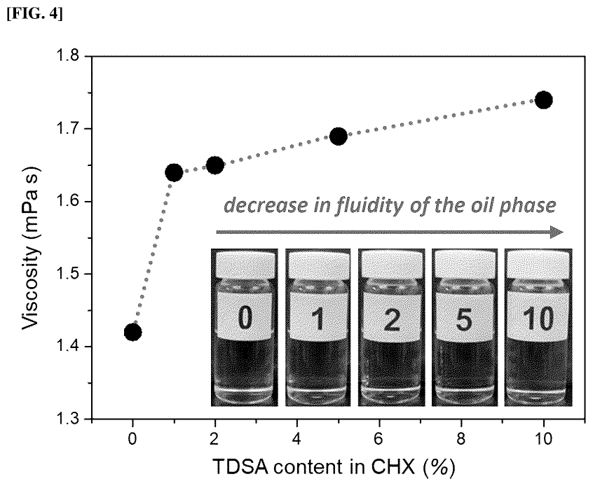

In addition, as the TDSA content in the CHX increased, the relative viscosity of the CHX solution also increased, leading to reduced fluidity. This, in turn, may delay the coalescence of smaller CHX droplets (FIG. 4).

TABLE 1

| | | CNC | | | |
|---|---|---|---|---|---|
| | | suspension | CHX | | |
| | | (0.2 wt | solution | D_{[4.3]} | Weight ratio |
| Sample | | %)(g) | (g) | (μm) | (CNC:TDSA) |
| Comparative | CNC95- | 95 | 5 | 7.4 | — |
| example | CHX05 | | | | |
| Exemplary | CNC95- | 95 | 5 (TDSA | 3.9 | 1:2.6 |
| embodiment | CHX05 | | 10 wt %) | | |
| | (TDSA10) | | | | |

### (2) Morphological Characteristics of the Pickering Emulsion

Referring to FIG. 2, the CNC-stabilized Pickering emulsions, of CNC95-CHX05(TDSA10) and CNC95-CHX05 were immediately frozen using liquid nitrogen. Afterwards, they were then freeze-dried, simultaneously removing both water and CHX, resulting in the formation of a dry and soft foam (FIG. 2).

During freeze-drying, a foam structure was formed due to the network structure introduced by CNC in the aqueous phase.

It was hypothesized that CNC and TDSA could be homogeneously and physically bonded at the CHX/water interface during freeze-drying.

In order to examine the cross-section, the frozen emulsion was cut under liquid nitrogen using a cryogenic preparation system, and its structure was observed via Cryo-SEM analysis at −90° C. under vacuum sublimation [top of FIG. 5].

The image of CNC95-CHX05 revealed hollow microcapsules densely covered with CNC aggregates, partially embedded under ice due to the partial sublimation of water and CHX molecules. This indicates that despite CHX sublimation, the capsule structure could be maintained by irreversibly adsorbed CNC at the interface [bottom left of FIG. 5].

In contrast, the image of CNC95-CHX05(TDSA10) showed that solid TDSA particles being roughly twisted were located inside the CNC shell and were tightly attached to each other (bottom right of FIG. 5).

In addition, the surface of the CNC95-CHX05(TDSA10) shell appeared smoother in comparison to the CNC95-CHX05 shell. This may be attributed to excess TDSA addition (CNC/TDSA weight ratio of 1/2.6) and the strong affinity between the hydrophilic CNC surface and the two polar carbonyl groups of TDSA.

Thus, during CHX sublimation, TDSA may have physically and uniformly adhered to the inner, intermediate, and outer layers of the shell, forming a network associated with CNC.

### (3) Hydrophobization of the CNC Surface via Thermal Esterification

Thermal esterification was conducted where TDSA was homogeneously adsorbed onto the CNC surface through Pickering emulsion, followed by freeze-drying and thermal esterification at 130° C. without a catalyst.

Referring to the left spectrum of FIG. 6, Fourier transform infrared (FT-IR) spectra were obtained to confirm the grafting of TDSA onto the CNC surface [TDSA-grafted CNC in FT-IR spectrum] via covalent bonding. The presence of a carbonyl (—C(═O)O—) peak was observed in the TDSA-grafted CNC at 1730 cm⁻¹ derived from the ester bond formed after esterification.

In addition, the intensity of the aliphatic —CH₂— stretching bands at 2980 cm⁻¹ and 2850 cm⁻¹, originating from the C14 alkyl and alkenyl chains of TDSA, increased, while the —OH peak of CNC at 3500-3300 cm⁻¹ decreased.

Moreover, during the washing process using an acetone/water cosolvent, the unreacted TDSA was effectively removed. Therefore, symmetric or asymmetric vibrations of anhydrous succinic acid (—C(═O)) were not observed at 1870 and 1780 cm⁻¹.

In contrast, in pure CNC [CNC in FT-IR spectrum] or unmodified CNC [unmodified CNC in FT-IR spectrum] which was obtained by washing the TDSA-mixed CNC from the Pickering emulsion without heat treatment, the carbonyl stretching band (—C(═O)O—) was not detected. The overall spectra of these two samples were highly similar, indicating that no esterification had occurred.

Furthermore, the peak at 1650 cm⁻¹, associated with the vibrations of adsorbed water, significantly decreased after surface modification, suggesting that the hydrophobic C14 alkyl and alkenyl chains were introduced onto the CNC surface.

These results support that TDSA was covalently grafted onto the CNC surface via thermal esterification, rather than physical interactions.

Referring to the right image of FIG. 6, the surface of the TDSA-grafted CNC, obtained after thermal esterification and subsequent washing, appeared thicker and smoother compared to the surface of the unmodified CNC, which was obtained by simply washing the TDSA-mixed CNC from the Pickering emulsion without heat treatment.

These surface changes resulted from the uniform coating of TDSA on the CNC surface via chemical bonding.

In order to further investigate CNC surface modification, X-ray photoelectron spectroscopy (XPS) analysis was performed.

As shown in FIG. 7, the XPS spectrum of CNC exhibited three strong C1 peaks and one weak C1 peak, respectively corresponding to C1 (C—C/C—H, 284.8 eV), C2 (C—O, 286.3 eV), C3 (C—O—C, 287.7 eV), and C4 (O—C═O, 288.9 eV) [top of FIG. 7].

However, in CNC-g-TDSA, the C4 (O—C═O) peak, which was hardly observed in CNC, increased by 156%, making it clearly distinguishable [bottom of FIG. 7].

This is because of the formation of ester bonds between the anhydride group of TDSA and the hydroxyl groups of the CNC surface.

In addition, due to the long hydrocarbon chains of TDSA, the intensity of the C1 (C—C/C—H) peak increased by up to 258% after surface modification.

The XPS results support that CNC was coated with TDSA via covalent bonding, such as ester linkages.

In order to evaluate the TDSA grafting efficiency, elementary analysis (EA) was conducted to determine the degree of substitution (DS) of cellulose.

The DS values of CNC and CNC-g-TDSA were determined using Equation 1 and corrected values from elementary analysis (Table 2), yielding values of 0.00 and 0.22, respectively (Table 3).

$$DS = \frac{{C}_{AGU} \text{?} {X}_{C} \times AGU}{{X}_{C} \times CTDSA - {C}_{TDSA}} \qquad [ Equation 1 ]$$

$$\text{?} \text{indicates text missing or illegible when filed}$$

Here, C_{AGU} is the carbon mass of AGU (72 g mol⁻¹), Xc is the corrected weight fraction of carbon obtained from CNC and CNC-g-TDSA, AGU is the total mass of an anhydroglucose unit (162 g mol⁻¹), CTDSA is the total mass of TDSA (294 g mol⁻¹), and C_{TDSA} is the carbon mass of TDSA (216 g mol⁻¹).

TABLE 2

| | Elemental weight composition | | | | | | | |
|---|---|---|---|---|---|---|---|---|
| | theoretical | | experimental | | corrected | | | |
| | values | | values | | values | | | |
| | C | O | C | O | C | O | | |
| Samples | (wt %) | (wt %) | (wt %) | (wt %) | (wt %) | (wt %) | DS | O/C |
| Anhydroglucose (AGU) | 44.4 | 49.4 | 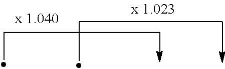 | | | | 0.00 | 1.11 |
| CNC | 44.4 | 49.4 | 42.7 | 48.3 | 44.4 | 49.4 | 0.00 | 1.11 |
| (CelluForce NCC*) | | | | | | | | |
| | | | 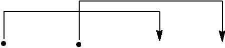 | | | | | |
| CGT | | | 50.8 | 40.2 | $2.8 | 41.1 | 0.22 | 0.78 |
| (TDSA-grafted-CNC) | | | | | | | | |

TABLE 3

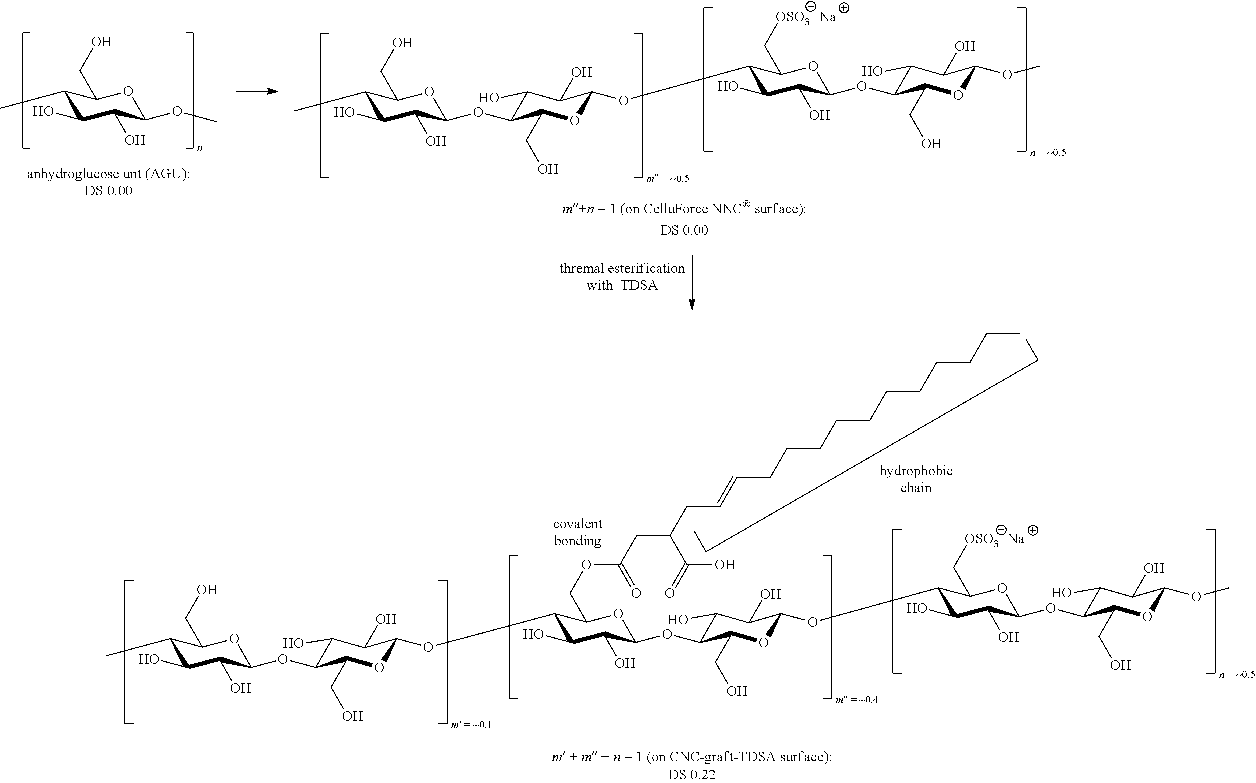

In order to calculate the weight ratio of CNC to TDSA in CNC-g-TDSA and to evaluate its thermal stability during thermal decomposition, thermogravimetric analysis (TGA) was performed.

The initial thermal decomposition temperature (T_{d onset}) and maximum decomposition temperature (T_{d max}) of CNC were 291° C. and 315° C., respectively.

These values may be attributed to the presence of sulfate half-esters on the CNC surface and the degradation of glycosyl units [top and bottom of FIG. 8, black solid line].

Meanwhile, the thermal decomposition of TDSA started at 223° C. and reached its maximum at 296° C. [top and bottom of FIG. 8, gray solid line].

As shown at the bottom of FIG. 8, the DTG (derivative thermogravimetric) curve indicates that the Td max peak of TDSA is significantly different from the Td max peak of CNC.

Thus, the DTG curve of CNC-g-TDSA [bottom of FIG. 8, gray bold line] exhibited two distinct decomposition stages, corresponding to the TDSA region (100-310° C.) and the CNC backbone (311-400° C.).

When integrating the DTG curve based on each of two regions, the weight ratio of CNC:TDSA was estimated to be approximately 70:30.

In addition, the T_{d max} of CNC in CNC-g-TDSA increased to 336° C. after chemical grafting, due to the presence of long hydrophobic chains (C14) covering the surface sulfate groups of CNC that is relatively vulnerable to heat.

In order to examine the crystal structure changes in CNC before and after thermal esterification, X-ray diffraction (XRD) analysis was performed [FIG. 9].

The XRD patterns of CNC and CNC-g-TDSA exhibited typical cellulose I crystalline structure including five 2θ peaks at 15° (1-10), 16.5° (110), 20.3° (102), 22.5° (200), and 34.5° (004).

The crystallinity index (CrI), a critical factor in evaluating the reinforcement effect, was determined using the peak height method.

The CrI values for CNC and CNC-g-TDSA were 78% and 68%, respectively.

The 10% reduction in CrI after surface modification is likely due to the high temperature during esterification (130° C., for 24 hours).

These results suggest that surface modification had hardly affected the crystalline structure of CNC-g-TDSA, indirectly confirming that the grafting of TDSA occurred only on the surface of CNC.

### (4) Hydrophobicity and Morphology of the Hydrophobic Cellulose Surface

Due to the intrinsically hydrophilic nature of CNC, achieving uniform dispersion in both organic solvents and non-polar polymers is challenging.

Thus, TDSA, which contains C14 alkyl and alkenyl chains, was grafted onto the CNC surface to improve dispersibility in organic solvents such as chloroform and toluene.

The wettability and dispersion stability tests shown in FIG. 10 were conducted to observe the dispersion behavior.

In the mixtures of water (upper phase)/CHCl₃ (lower phase) and water (lower phase)/toluene (upper phase) [the weight ratio of water:solvent is 1:1], CNC remained dispersed in the aqueous phase after simple shaking [the hydrophobicity of FIG. 10, middle].

In contrast, CNC-g-TDSA exhibited completely opposite behavior compared to CNC in both the water/CHCl₃ and water/toluene mixtures. CNC-g-TDSA preferentially migrated into the non-polar solvents such as CHCl₃ and toluene, confirming its higher affinity for these solvents compared to CNC [the hydrophobicity of FIG. 10, right].

In addition, these results demonstrate that CNC became less polar and more hydrophobic after surface modification.

In order to further investigate the nanodispersion stability over time, CNC and CNC-g-TDSA were dispersed in water, CHCl₃, and 0.1 wt % toluene via brief vortex mixing and ultrasonication [the dispersion stability of FIG. 10]. Colloidal stability was assessed by the Tyndall scattering effect.

CNC remained uniformly dispersed in water with a uniform and transparent appearance due to the presence of sulfate half-ester groups on the surface, and retained its dispersion stability for 24 hours.

However, when CNC-g-TDSA was dispersed in water, greater light diffusion was observed, which decreased after 24 hours. This suggests that the hydrocarbon chains of CNC-g-TDSA hinder interactions with water, leading to eventual aggregation.

Despite this, partial colloidal dispersion of CNC-g-TDSA was still observed even after 24 hours, which may be attributed to surface charge repulsion by both the sulfate half-ester groups and free carboxylic acids formed via ring-opening esterification [the dispersion stability of FIG. 10, left].

This explanation reasonably aligns with the fact that CNC-g-TDSA has a zeta potential value of −42 mV in water.

In addition, CNC-g-TDSA exhibited clear red lines formed by light scattering in CHCl₃ and toluene, indicating excellent colloidal stability. In contrast, CNC immediately aggregated and precipitated in these solvents [the dispersion stability of FIG. 10, middle and right].

However, after 24 hours, the dispersion stability of CNC-g-TDSA in toluene was lower than the dispersion stability of CNC-g-TDSA in CHCl₃, as slow precipitation was observed in toluene [the dispersion stability of FIG. 10, right].

This may be due to the lower polarity index of toluene (2.4) compared to the polarity index of CHCl₃ (4.1) and the presence of some unmodified regions on the CNC-g-TDSA surface (DS value: 0.22).

Nevertheless, the colloidal dispersion stability of CNC-g-TDSA in both chloroform (CHCl₃) and toluene suggests that CNC hydrophobicity was enhanced through TDSA grafting.

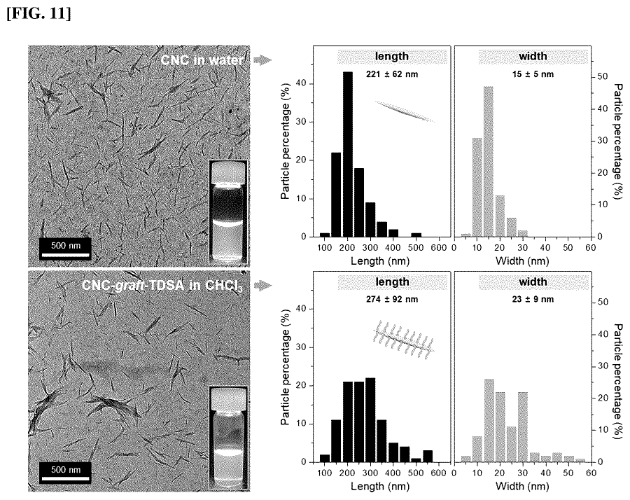

Representative TEM images and size distribution histograms of CNC and CNC-g-TDSA dispersed in water and CHCl₃ were prepared [FIG. 11].

The TEM images on the left of FIG. 11 showed that both CNC and CNC-g-TDSA were uniformly distributed without large aggregates and generally exhibited a needle-like morphology in water and CHCl₃, respectively.

According to the size distribution histogram on the right of FIG. 11, the average length and width of CNC-g-TDSA dispersed in CHCl₃ increased from 221±62 nm to 274±92 nm and from 15±5 nm to 23±9 nm, respectively, compared to CNC dispersed in water.

This may be attributed to differences in swelling behavior between CNC in water and CNC-g-TDSA in CHCl₃, where a small portion of CNC-g-TDSA aggregates due to hydrophobic interactions between the C14 alkyl and alkenyl chains of TDSA [left of FIG. 11, bottom].

Nonetheless, the aspect ratio (length/width) of CNC-g-TDSA was similar to the aspect ratio (length/width) of CNC, following the known range of 5-50 for typical rod-shaped CNCs.

Meanwhile, in order to assess the surface characteristics of CNC before and after TDSA esterification, dynamic water contact angle (WCA) was measured over time to determine surface wettability, as shown in FIG. 12.

The introduction of hydrophobic alkenyl chains from TDSA onto the CNC surface significantly increased the average WCA value from 34° (for pure CNC) to 90° (for CNC-g-TDSA).

In addition, the WCA value of CNC-g-TDSA remained at 90° for over 30 seconds, indicating higher hydrophobicity and reduced water-wettability, whereas the WCA value of CNC disappeared after 8 seconds.

These results are reasonably consistent with XPS and EA findings [FIG. 7 and Table 2], further supporting the enhanced dispersion of CNC-g-TDSA in hydrophobic organic solvents [FIG. 11].

In the above, exemplary embodiments of a method for preparing hydrophobic cellulose using Pickering emulsion and hydrophobic cellulose prepared using the same according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

What is claimed is:

1. A method for preparing hydrophobic cellulose, the method comprising:
preparing an oil-in-water Pickering emulsion of a suspension of cellulose (aqueous solution) and a solution in which an acid anhydride is mixed with an organic solvent (oleaginous solution); and
freeze-drying and then heat treatment of the freeze-dried emulsion.

2. The method of claim 1,
wherein the acid anhydride is represented by Chemical Formula 1. 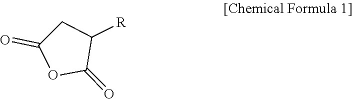
In Chemical Formula 1, R is a C₅₋₂₀ alkyl or alkylene group.

3. The method of claim 1,
wherein a weight ratio of the aqueous solution to the oleaginous solution ranges from 80:20 to 99:1.

4. The method of claim 3,
wherein a content of the cellulose in the aqueous solution ranges from 0.01 to 2 wt %.

5. The method of claim 3,
wherein a content of the acid anhydride in the oleaginous solution ranges from 1 to 20 wt %.

6. The method of claim 1,
wherein a weight ratio of the cellulose to the acid anhydride ranges from 1:1 to 1:10.

7. The method of claim 1,
wherein the emulsion is stabilized by the cellulose at an interface between an aqueous phase and an oleaginous phase.

8. The method of claim 1,
wherein an average diameter of droplets of the emulsion ranges from 2 to 6 μm.

9. The method of claim 1,
wherein the freeze-drying of the emulsion forms a cellulose capsule internally coated with a hydrophobic chain derived from the acid anhydride.

10. The method of claim 1,
wherein the heat treatment causes the acid anhydride to form a covalent bond with a hydroxyl group of the cellulose, resulting in grafting.

11. The method of claim 1,
wherein the heat treatment is performed at a temperature ranging from 100 to 170° C.

12. A hydrophobic cellulose capsule internally coated with hydrophobic chains derived from acid anhydrides.

13. Hydrophobic cellulose grafted with hydrophobic chains derived from acid anhydrides.

14. The hydrophobic cellulose of claim 13,
wherein cellobiose grafted with the acid anhydride accounts for 20 to 60 mol % of the hydrophobic cellulose.

15. The hydrophobic cellulose of claim 13,
wherein a degree of substitution (DS) of hydroxyl groups (—OH) in the hydrophobic cellulose ranges from 0.05 to 1.

16. The hydrophobic cellulose of claim 13,
wherein a weight ratio of the acid anhydride to the cellulose ranges from 20:80 to 40:60.
